(19) United States
(12) Patent Application Publication
(10) Pub. No.: US 2018/0298272 A1
(43) Pub. Date: Oct. 18, 2018

(54) POLYMERIC AND ELASTOMERIC PROPPANT PLACEMENT IN HYDRAULIC FRACTURE NETWORK

(71) Applicant: SCHLUMBERGER TECHNOLOGY CORPORATION, Sugar Land, TX (US)

(72) Inventors: Meng Qu, Waltham, MA (US); Agathe Robisson, Cambridge, MA (US); Francois Auzerais, Boston, MA (US); Shitong S. Zhu, Waban, MA (US); Yucun Lou, Belmont, MA (US)

(73) Assignee: SCHLUMBERGER TECHNOLOGY CORPORATION, Sugar Land, TX (US)

(21) Appl. No.: 15/766,513

(22) PCT Filed: Aug. 11, 2016
(86) PCT No.: PCT/US2016/046440

§ 371 Date: Apr. 6, 2018

Related U.S. Application Data
(60) Provisional application No. 62/237,493, filed on Oct. 5, 2015.

(51) Int. Cl. C09K 8/80; C09K 8/64; C09K 8/68; C09K 8/60; E21B 43/267

(52) U.S. Cl. CPC C09K 8/80; C09K 8/64; C09K 2208/10; C09K 8/601; E21B 43/267; C09K 8/68

(57) ABSTRACT

Methods may include treating a subterranean formation penetrated by a wellbore, including: pumping a treatment fluid containing one or more polymeric proppants into the formation at a pressure sufficient to initiate a fracture, wherein the one or more polymeric proppants are composed of one or more polymers selected from a group of polyethylene, polypropylene, butylene, polystyrenes (PS) and copolymers thereof, high-impact grafted polystyrene (HIPS), acrylic polymers, methacrylic polymers, polyvinyl chloride (PVC), polyvinyl acetate (PVA), polycarbonate (PC), hydrogenated nitrile butadiene rubber (HNBR), ethyelene propylene diene monomer (EPDM), polydimethylsiloxane (PDMS), natural rubber, polystyrene-polybutadiene (PS-PB) copolymers, polymethylmethacrylate (PMMA), polystyrene-block-polymethylmethacrylate (PS-b-PMMA), acrylonitrile butadiene styrene (ABS), and epoxy resins. Methods may also include introducing a multistage treatment fluid comprising one or more stages of a polymeric proppant-containing fluid and one or more stages of a spacer fluid into one or more intervals of a wellbore.

### CROSS REFERENCE TO RELATED APPLICATIONS

This application claims priority from U.S. Ser. No. 62/237,493, filed Oct. 5, 2015, entitled “Polymeric and elastomeric proppant placement in hydraulic fracture network”, the contents of which are incorporated herein by reference.

### BACKGROUND

Fracturing operations conducted in a subterranean formation may enhance the production of fluids by injecting pressurized fluids into the wellbore to induce hydraulic fractures and flow channels connecting isolated reservoirs. Fracturing fluids may deliver various chemical additives and proppant particulates into the formation during fracture extension. Following the injection of fracture fluids, proppants injected into the fractures prevent closure as applied pressure decreases below the formation fracture pressure. The propped open fractures then allow fluids to flow from the formation through the proppant pack to the production wellbore.

The success of the fracturing treatment may depend on the ability of fluids to flow from the formation through the proppant pack installed after initiating the fracture. Particularly, increasing the permeability of the proppant pack relative to the formation may decrease resistance to the flow of connate fluids into the wellbore. Further, it may be desirable to minimize the damage to the surface regions of the fracture to maximize connected porosity and fluid permeability for optimal flow from the formation into the fracture.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, methods of the present disclosure may be directed to treating a subterranean formation penetrated by a wellbore, including: pumping a treatment fluid containing one or more polymeric proppants into the formation at a pressure sufficient to initiate a fracture, wherein the one or more polymeric proppants are composed of one or more polymers selected from a group of polyethylene, polypropylene, butylene, polystyrenes (PS) and copolymers thereof, high-impact grafted polystyrene (HIPS), acrylic polymers, methacrylic polymers, polyvinyl chloride (PVC), polyvinyl acetate (PVA), polycarbonate (PC), hydrogenated nitrile butadiene rubber (HNBR), ethyelene propylene diene monomer (EPDM), polydimethylsiloxane (PDMS), natural rubber, polystyrene-polybutadiene (PS-PB) copolymers, polymethylmethacrylate (PMMA), polystyrene-block-polymethylmethacrylate (PS-b-PMMA), acrylonitrile butadiene styrene (ABS), and epoxy resins.

In another aspect, methods may include introducing a multistage treatment fluid into one or more intervals of a wellbore, wherein the multistage treatment fluid comprises one or more stages of a polymeric proppant-containing fluid and one or more stages of a spacer fluid.

Other aspects and advantages of the invention will be apparent from the following description and the appended claims.

### BRIEF DESCRIPTION OF FIGURES

FIGS. 1 and 2 are illustrations of fracturing treatments within a formation fracture in accordance with embodiments of the present disclosure;

FIG. 3 is an illustration of the delivery of a treatment fluid pumping sequence into a fractured wellbore interval in accordance with embodiments of the present disclosure;

FIG. 4 is an illustration of the delivery of a treatment fluid pumping sequence into a fractured wellbore interval in accordance with embodiments of the present disclosure; and

FIGS. 5 and 6 are illustrations showing the response of polymeric proppants in accordance with the present disclosure in response to closure stress within a formation fracture.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

Embodiments of the present disclosure are directed to the use of polymeric proppants having controlled mechanical properties and densities. Polymeric proppants in accordance with the present disclosure may be used in wellbore applications and fracturing operations as additives that prop open natural and existing fractures, and may function as fluid loss control materials in some embodiments. In some embodiments, polymeric proppants may be added during the pad stage, to prop any initiated fracture networks and improve fracture conductivity within a reservoir, including unconventional reservoirs such as shales.

In some embodiments, polymeric proppants in accordance with the present disclosure may modify fluid conductivity in induced fractures, be used as a component of an initiation pad, and be used to treat regions of the formation where finer fractures may render proppant delivery more difficult. Methods of the present disclosure may be employed at any stage of the formation fracturing process and may be used to stabilize the entire fracture network, including natural and pre-existing fractures and induced hydraulic fractures. In one or more embodiments, methods of improving fracture conductivity using polymeric proppants may be applied to unconventional reservoirs, including shales and fractured reservoirs.

In one or more embodiments, polymeric proppants in accordance with the present disclosure may be emplaced within a formation as a single or multistage fracturing fluid that generates polymeric proppant “pillars” that stabilize fractures within a given formation. Pillars in accordance with the present disclosure are load-bearing solid support structures that hold fractures open to allow reservoir production from fracture networks. In some embodiments, polymeric proppants may be emplaced within one or more regions of a wellbore, such as during sequential fracturing operations within different intervals of the wellbore.

Hydraulic fracturing involves pumping fluid into a well faster than the fluid can escape into the formation, which increases pressure against the formation walls until the formation breaks. When the breakdown of the formation occurs, fracture growth exposes new formation area to the injected fluid and continued pumping may be required to compensate for fracturing fluids that enter the formation to propagate and grow fractures. During this process, fractures are held open by hydraulic pressure and proppants may be added to hold fractures open after the cessation of pumping and to maintain conductive flow paths during production. During the initial stages of a fracturing operations, a pad fluid may be injected to break down the wellbore, initiate the fracture and produce sufficient penetration and width to allow the proppant laden fluid stages to later enter the fracture after the pad is pumped. In some cases, fracture penetration may be limited due to high fluid loss near the wellbore and, as a result, fracture tips may contain pad fluid with little to no proppant.

Treatment fluid stages in a fracturing operation may be designed such that injected stages are delivered into the wellbore at a predetermined location and time, with a pre-set concentration of proppant in the initial proppant pad lost to the formation and the first proppant stage ending right at the fracture tip. However, fluid loss in fracturing operations may occur at the tip of the fracture as a proppant-laden slurry flows through the fracture faster than the tip propagates resulting in the slurry eventually overtaking the fracture tip. Due to fluid loss to the formation during this process, pad and the slurry stages may lose fluid, causing an increase in proppant concentration as slurry stages dehydrate, which can lead to uneven proppant distribution and reduced fluid conductivity through blockage formation.

In unconventional reservoirs, the type of formation matrix fractured is of much less porosity and permeability than a comparative sandstone reservoir, with permeability in the nano-Darcy range. As such, fluid losses to the formation during hydraulic fracturing may not be so prevalent and pad fluids injected experience less fluid loss and dehydration. As a result, the first proppant stage pumped behind the pad may not reach the fracture tip, and instead remain behind the pad fluid, which may continue to propagate and extend the tip of the original fracture or initiate and propagate new un-propped and fragmented fracture networks. In such cases, it is possible that the pad will initiate a fracture network that a proppant slurry will not enter, creating unpropped fractures that close following the cessation of pumping. On the other hand, the slurry may fracture an area that the pad will not enter. In other cases, slick water jobs may create a narrow network of channels that may not permit transport of conventional proppant. Thus, for all the aforementioned reasons, a fractured network initiated far away from the borehole during the fracturing of a reservoir may remain un-propped and isolated from production, particularly in an unconventional formation.

Methods in accordance with the present disclosure may incorporate polymeric proppants at various stages of a fracturing operations. As introduced above, pad fluids may be injected at the initial stages of a fracturing operation, but, in the absence of sufficient leak-off, pad fluids may accumulate in fracture tips, which may lead to fracture tips closing and, accordingly, decreased production from these sections of a fracture. In one or more embodiments, polymeric proppants may be added to a pad fluid, a single-stage fracturing fluid, and/or a multistage fracturing fluid, and to prop open the entire length of a fracture, including narrow fracture tips.

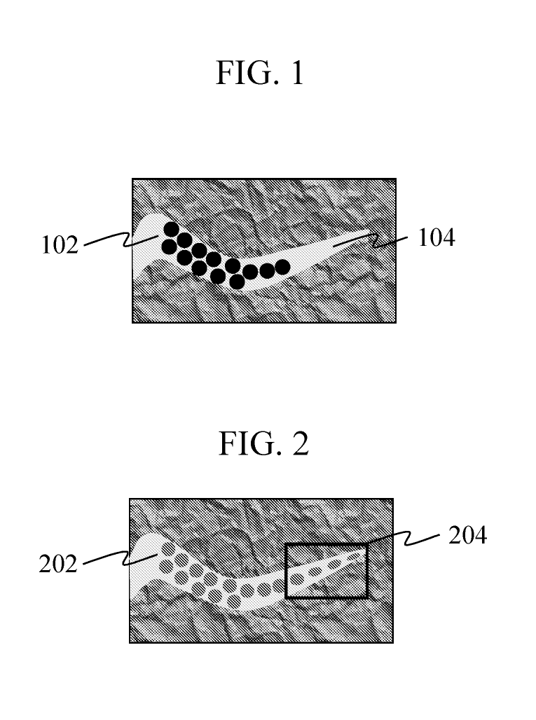

With particular respect to FIG. 1, a diagram depicting a rigid, non-deformable proppant 102, such as ceramic or sand, is shown emplaced within a fracture. During pumping, the distance within the fracture occupied by the wellbore fluid is referred to as the hydraulic length, while the unoccupied region of the fracture tip in this scenario is referred to as the lag length. In some embodiments, the concentration of proppant may remain relatively constant along the hydraulic length of the fracture until the proppant pack reaches the tip of the fracture where proppant placement becomes limited due to a number of factors including size and pressure constraints. In FIG. 1, proppant 102 is unable to reach narrow fracture tip due to dimensional and mechanical constraints, creating lag length 104 within the fracture.

In one or more embodiments, polymeric proppants may be used to prop open the tips of natural or induced fractures to increase conductivity in the near wellbore area. With particular respect to FIG. 2, a diagram depicting the use of polymeric proppant 202 in accordance with the present disclosure is shown. Unlike non-deformable proppants in FIG. 1, polymeric proppants 202 may have properties, such as a favorable density and ductility, which allow the proppants to be carried further into the fracture and to compress to some degree as the fracture tip 204 narrows. With polymeric proppants emplaced within the fracture tips, the fracture may be held open to a greater degree with a corresponding increase in conductivity and fluid production.

Polymeric proppants in accordance with the present disclosure may have properties that differ from rigid and/or crystalline proppants that include modified mechanical properties such as increased ductility and lower density. For example, in some embodiments, the density of the polymeric proppant may be lower or comparable to the treatment fluid used to deliver the particles, allowing a decreased pumping rate to be used without excessive proppant settling. In addition, increased ductility may allow polymeric proppants to deform slightly when travelling through narrow and wavy fractures, which may reduce particle settling before reaching the pad or fracture tip, screen out, and early blockage of the fracture is minimized instead of blocking or bridging as non-deformable proppant would do in low-width areas.

In one or more embodiments, methods in accordance with the present disclosure may involve creating staged fractures along a wellbore by injecting pressurized treatment fluids to initiate fractures in the formation. In some embodiments, a fracture fluid pad may be followed by injecting a multistage treatment fluid having one or more stages that contain polymeric proppant partitioned by a spacer fluid. In some embodiments, polymeric proppants may be incorporated into the pad stage of a fracturing treatment, while later stages contain a mixture of polymeric proppants and standard proppants, or standard proppants alone. For example, polymeric proppants in accordance with the present disclosure may be incorporated as a component of a pad fluid, wherein polymeric proppants may be delivered to the tip of the fracture network and remain within the fracture following the cessation of fluid pumping.

However, depending on the properties of the treatment fluid, fracture fluid pads may be omitted in some embodiments and a single stage or multistage treatment fluid may be used directly to generate sufficient hydraulic fracture width and provide better fluid loss control. In some embodiments, polymeric proppants can be used alone within a single- or multi-stage treatment fluid, or may be combined with rigid proppants such as ceramics or sand. In still other embodiments, multistage treatment fluids may include one or more stages containing energized fluids or foams including a gaseous component such as nitrogen, carbon dioxide, air, or a combination thereof.

In one or more embodiments, polymeric proppants may be formulated as a fracturing fluid that is injected as a relatively homogenous fluid, or as a treatment fluid sequence containing “pulses” or intervals of proppant-containing fluid and proppant-free fluid (with or without filler material). In some embodiments, treatment with a polymeric proppant-containing treatment may be repeated for multiple stage fracturing operations, including operations within deviated and horizontal wells.

In one or more embodiments, polymeric proppants may be introduced as a stage of a multistage fracture fluid and alternatively injected (or pulsed) into a wellbore with a second fluid stage containing a spacer fluid into a wellbore. In some embodiments, depending on the requirements of a particular operation, additional fluid stages containing proppants at concentrations that differ from a first polymeric proppant-containing fluid may be incorporated into a multistage treatment. Polymeric proppants in accordance with the present disclosure may be combined with a fracture fluid alone or as a combination of standard proppants and polymeric proppant.

Multistage treatment fluids in accordance with the present disclosure may contain a predetermined sequence of stages of fluid volumes or “pulses,” including one or more stages of a polymeric proppant-containing composition that create a series of polymer pillars that function to prop open fractures and provide regions of increased permeability through the hydraulically fractured network. When employed during fracturing operations, polymeric proppant-containing composition may be emplaced within an interval of a wellbore during fracture initiation, enter into the fractures, and aggregate to generate support structures that prop open the fractures without damaging the overall fracture network. In some embodiments, polymeric proppant-containing materials may be selected such that the formation of the polymeric material occurs before the fracture closure stress seals opened fractures. Polymerized materials deposited from the polymeric proppants may then hold existing and newly formed fractures open, while eliminating or minimizing uncontrolled propagation of fractures from the wellbore. Moreover, during production, polymeric pillars generated may hold fractures open at discrete locations while reservoir fluids are transported through open channels and voids between the pillars.

In one or more embodiments, methods in accordance with the present disclosure may include emplacing a multistage treatment fluid containing fluid stages of polymeric proppants in combination with spacer fluid stages that function to separate the polymeric proppant-containing stages. In some embodiments, spacer fluid stages may also contain various additives such as degradable solids and fillers that may be removed following emplacement and curing of the polymer-containing components of the treatment fluid. For example, following the injection of a multistage treatment fluid, degradable filler materials used to partition the polymeric proppant pillars may degrade upon exposure to formation temperatures or aqueous connate fluids or be removed by the injection of aqueous fluids, solvents or degrading agent such as an acid, base, enzyme, or oxidizer.

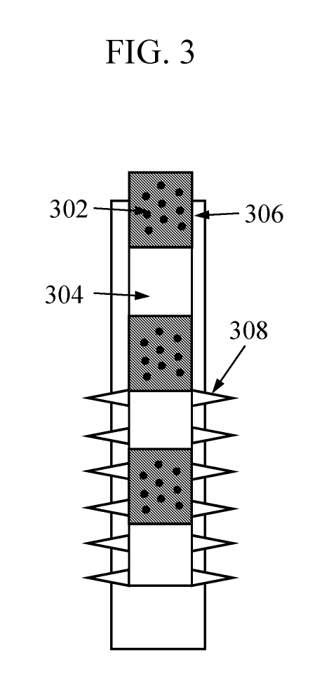

With particular respect to FIG. 3, a wellbore 306 is shown having a number of fractures 308 into which a multistage treatment fluid in accordance with the present disclosure is pumped. The multistage treatment fluid contains a sequence of component fluids that include a spacer fluid 304 and polymeric proppant-containing component 302. Following placement, the polymeric proppant-containing component 302 of the treatment fluid may form polymeric clusters or pillars in fractures with interspersed channels that increase the permeability of the formation to fluid flow. In some embodiments, pulse pumping a multistage sequence may also reduce the possibility of particle bridging or screen-out during treatment. In one or more embodiments, the spacer fluid 304 may be aqueous, oleaginous, an invert or direct emulsion, or a foam having a gaseous internal phase such as nitrogen or carbon dioxide.

In one or more embodiments, polymeric proppants may have density and viscosity that are compatible with the spacer fluid to maintain fluid interface stability and avoid mixing the stages, or in embodiments in which there is no fluid interface stability issue during pumping, the spacer fluid 304 may be a standard fracturing fluid. In some embodiments, the variation in density and viscosity may also be accounted for by combining one or both stages with additives such as solids and surfactants that modify the rheology of the treated stage. For example, a polymeric or viscoelastic rheology modifier may be added to the spacer fluid and/or the polymeric proppant-containing component to control fluid loss and selected by considering fracture network geometry such as width, height, length, branchedness, to remedy fluid loss and leak off of fluid treatments into the formation.

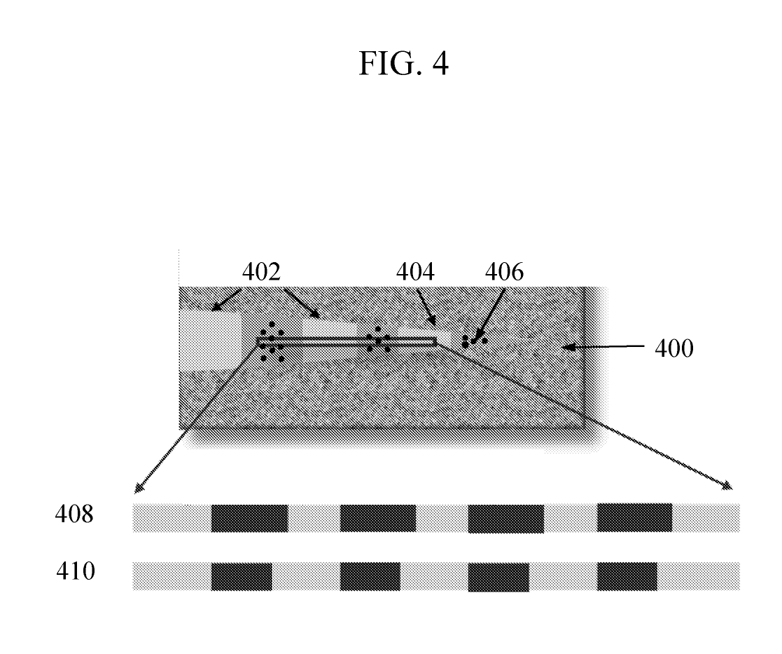

In one or more embodiments, treatment fluid stages may vary in volume from one operation to another. For example, the size of the proppant pillars and the spacing between may be tunable by changing the pumping schedule of the pulse pumping strategy. With particular respect to FIG. 4, an example of a pulse pumped fluid treatment in accordance with the present disclosure is shown. A fracture 404 in a formation 400 contains an injected treatment fluid having alternating stages of polymeric proppant-containing component 406 and spacer fluid 402. In some embodiments, control over the size of the polymer pillars may involve increasing the ratio of the polymeric proppant-containing fluid component with respect to the spacer fluid interval as shown in pumping schedule 408. Conversely, with a shorter pumping interval for the polymeric proppant-containing component, smaller pillars may be obtained. The spacing between pillars may also be controlled by adjusting the spacer fluid stages between the polymeric proppant-containing component stages in the pumping schedule as shown in 410.

The volume of the spacer fluid 402 and polymeric proppant-containing component 406 may vary with respect to each other and may change during the duration of the job. In one or more embodiments, the ratio of the volume of the polymeric proppant-containing component to spacer fluid may range from 1:0.1 to 0.1:1. In some embodiments, the ratio of the polymeric proppant-containing component to spacer may range from 1:0.5 to 0.5:1. The volume of the polymeric proppant-containing pulse versus the spacer fluid may also be adjusted in some embodiments to suit various formation parameters such as porosity, elastic modulus, and the like. In some embodiments, the polymeric proppant-containing composition will be administered in a gated fashion, or switched on an off while the aqueous phase is continuously pumped.

In some embodiments, one or more stages of polymeric proppant-containing fluid and one or more stages of spacer fluid may be injected in volumes that range from 2 to 10 oilfield barrels (bbl). Treatment fluid stages may be injected in alternating fashion in sequence in which each stage is pumped for a duration that may range from 5 to 20 seconds, or from 10 to 15 seconds in some embodiments. Methods in accordance with the present disclosure may utilize injection rates that may range from 5 to 60 bbl/min in some embodiments, and from 10 to 50 bbl/min in some embodiments. The relative volume of the injected stages of polymeric proppant-containing component and spacer fluid and the pulse pumping time in the pumping schedule may vary with respect to each other in some embodiments, and may change during the execution of a given operation.

In one or more embodiments, the concentration of polymeric proppant in a wellbore fluid may be tuned so that the concentration of the polymeric proppant is below a level to form bridges or other aggregates that create blockages in the fracture prior to reaching the fracture tip, and may be at a level that ensures the height of the fracture is large enough to maintain the increased permeability. The concentration of the polymeric proppant in the single-phase treatment fluid or within one or more stages of a multistage treatment fluid may be in the range of 0.1 pounds per barrel (ppb) to 14 ppb in some embodiments, and from 0.5 ppb to 12 ppb in other embodiments.

In one or more embodiments, polymeric proppants may have a density that is approximate to, or lower than, the surrounding treatment or fracturing fluids. For example, in embodiments in which the density of the polymeric proppant is lower than the surrounding fluid, buoyancy of the fracture fluid may prevent premature settling or sag of the polymeric proppant prior to emplacement within a fracture, decreasing the risk of plugging the fracture channel. Polymeric proppants in accordance with the present disclosure may have a density within the range of 0.5 g/cm³ to 1.7 g/cm³ in some embodiments, and from 0.9 g/cm³ to 1.5 g/cm³ in some embodiments.

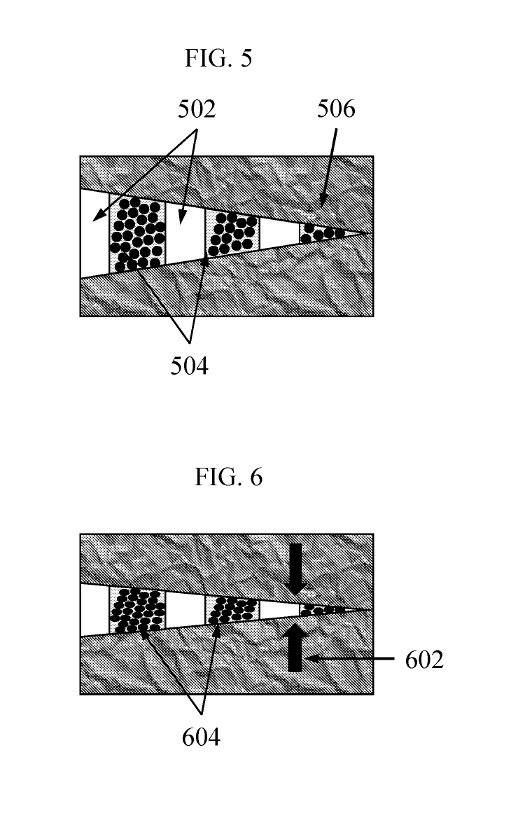

Following emplacement of polymeric proppant and the generation of pillars, induced and natural fractures may be propped open, increasing formation permeability. With particular respect to FIG. 5, voids and channels 502 are created around the solid pillars 504 within the formation fracture 506. Further, polymeric proppants may be deformable in some embodiments, and may compress to some degree. With particular respect to FIG. 6, closure stress generated by the formation 602 may deform the proppant pillars 604, reducing formation stress that could otherwise extend fractures in an uncontrolled fashion, while still increasing conductivity from the formation to the wellbore for hydrocarbons and other connate fluids.

Polymeric proppants in accordance with the present disclosure may possess mechanical properties that allow the particles to deform in order to travel further into natural and induced fracture tips. In one or more embodiments, polymeric proppants may have an elastic modulus of, for example, between about 500 psi and about 2,000,000 psi at formation conditions, between about 5,000 psi and about 200,000 psi, or between about 7000 psi and about 150,000 psi.

Polymeric Proppant

Polymers used to prepare polymeric proppants in accordance with the present disclosure include elastomers and thermoplastics, and may include polymers or higher order polymers such as co-polymers, crosslinked polymers, graft polymers, and the like. Polymeric proppants may also be prepared from ductile polymers or elastomers that enable some degree of particle deformation to enhance proppant placement at fracture tips. For example, ductility, stiffness, and material toughness for polymeric proppants may be achieved in some embodiments by tuning the crosslinking density of elastomers, the crystallinity of polymers, and the material compositions by using additives such as polymer blends, fillers, plasticizers, reinforcing agents, and the like.

Polymers that may be used to prepare polymeric proppants in accordance with the present disclosure may include thermoplastics, thermosets, rubbers, elastomers, thermoplastic elastomers, and the like. Thermoplastics may include polyolefins such as polyethylene, polypropylene, and butylenes, polystyrenes (PS) and copolymers thereof, acrylic polymers, methacrylic polymers, polyvinyl chloride (PVC), polyvinyl acetate (PVA), polycarbonate (PC), and the like. Elastomers that may be used in accordance with methods of the present disclosure may include any elastomer containing monomers and prepolymers capable of dissolving in a solvent before crosslinking, and then crosslink to form a solid phase, such as hydrogenated nitrile butadiene rubber (HNBR), ethyelene propylene diene monomer (EPDM), polydimethylsiloxane (PDMS), natural rubber etc. Copolymers that may be used in accordance with methods of the present disclosure include copolymers derived from any of the above polymers such as polystyrene-polybutadiene (PS-PB) copolymers, block copolymers such as polystyrene-block-polymethylmethacrylate (PS-b-PMMA), acrylonitrile butadiene styrene (ABS), and the like. In one or more embodiments, co-polymer compositions may be tuned to achieve the desired plastic and elastic behavior by a number of techniques including monomer selection, modification of the polymer backbone with charged or hydrophobic functional groups, tuning the molecular weight, and the like.

In one or more embodiments, polymeric proppants may include one or more epoxy resins or epoxy-containing species. In some embodiments, epoxy resins may include aromatic and aliphatic epoxy resins. Suitable aromatic epoxy resins may include bisphenol A epoxy, bisphenol AP epoxy, bisphenol AF epoxy, bisphenol B epoxy, bisphenol BP epoxy, bisphenol C epoxy, bisphenol C epoxy, bisphenol E epoxy, bisphenol F epoxy, bisphenol G epoxy, bisphenol M epoxy, bisphenol S epoxy, bisphenol P epoxy, bisphenol PH epoxy, bisphenol TMC epoxy, bisphenol Z epoxy, glycidylamine epoxy, novolac epoxy, and mixtures thereof. Suitable aliphatic epoxy resins may include any cycloaliphatic epoxy resins and aliphatic polyol-based epoxy resins.

In one or more embodiments, the thermal and mechanical properties of polymeric proppants may be tuned by incorporating various additives. For example, additives may include nanoparticles, microparticles, and fibers. In some embodiments, polymeric proppants may incorporate reinforced nanoparticles or fillers such as carbon black, clay nanoparticles, silica, alumina, zinc oxide, magnesium oxide, and calcium oxide. Reinforced fiber fillers suitable for incorporation into polymeric proppants may include carbon fiber, glass fibers, polyether-ether-ketone (PEEK) fibers, polymethyl methacrylate (PMMA) fibers, and cellulosic fibers. In some embodiments, polymeric particles may also be compounded with a cementitious particles and cement additives such as magnesium oxide.

In one or more embodiments, the polymeric proppant may incorporate water-reactive or water-absorbing materials that create a stiffer particle or aggregate upon exposure to aqueous fluids, creating increase resistance to fracture closing and increase fracture opening in some embodiments. Water-absorbing materials that facilitate diffusion of aqueous fluids into the material, increasing surface area exposure and increasing the observed degradation rate at a given temperature. Examples of materials useful as water absorbing fillers in accordance with the present disclosure include NaCl, ZnCl₂, CaCl₂, MgCl₂, Na₂CO₃, K₂CO₃, KH₂PO₄, K₂HPO₄, K₃PO₄, sulfonate salts, such as sodium benzenesulfonate (NaBS), sodium dodecylbenzenesulfonate (NaDBS), water absorbing clays, such as bentonite, halloysite, kaolinite, and montmorillonite, water soluble/hydrophilic polymers, such as poly(ethylene-co-vinyl alcohol) (EVOH), modified EVOH, super absorbent polymers, polyacrylamide or polyacrylic acid and poly(vinyl alcohols), poly(methacrylic acid), poly(acrylic acid-co-acrylamide), poly(acrylic acid)-graft-poly(ethylene oxide), poly(2-hyroxyethylmethacrylate), starch-grafted polymers, and the mixture of these fillers and derivatives thereof. Water-absorbing materials may be incorporated into polymeric proppants in accordance with the present disclosure at a percent by weight of the polymeric proppant (wt %) that ranges from 0.01 wt % to 5 wt % in some embodiments, and from 0.1 wt % to 4 wt % in some embodiments.

In one or more embodiments, polymeric proppants in accordance with the present disclosure may be spherical, substantially spherical, disc-like, oblate, or rod-like in structure. In some embodiments, polymeric proppants may possess a diameter (or length for proppants having an asymmetric aspect ratio) having a lower limit equal to or greater than 10 nm, 100 nm, 500 nm, 1 μm, 5 μm, 10 μm, 100 μm, 500 μm, and 1 mm, to an upper limit of 10 μm, 50 μm, 100 μm, 500 μm, 800 μm, 1 mm, and 10 mm, where the diameter (or length for proppants having an asymmetric aspect ratio) of the polymeric proppant may range from any lower limit to any upper limit.

In one or more embodiments, degradable fibers may be combined with a fluid containing polymer proppants to enhance cohesion of polymeric proppants and formation of pillars once emplaced downhole. The degradable fibers can be made of any degradable homopolymers of lactic acid, glycolic acid, hydroxybutyrate, hydroxyvalerate and epsilon caprolactone; random copolymers of at least two of lactic acid, glycolic acid, hydroxybutyrate, hydroxyvalerate, epsilon caprolactone, L-serine, L-threonine, and L-tyrosine; block copolymers of at least two of polyglycolic acid, polylactic acid, hydroxybutyrate, hydroxyvalerate, epsilon caprolactone, L-serine, L-threonine, and L-tyrosine; homopolymers of ethylenetherephthalate (PET), butylenetherephthalate (PBT) and ethylenenaphthalate (PEN); random copolymers of at least two of ethylenetherephthalate, butylenetherephthalate and ethylenenaphthalate; block copolymers of at least two of ethylenetherephthalate, butylenetherephthalate and ethylenenaphthalate; nylons; starch fibers; and combinations of these.

In one or more embodiments, treatment fluids may include a variety of functional additives to improve fluid properties and to mitigate formation damage. In some embodiments, functional additives may include scale inhibitors, demulsifiers, wettability modifiers, formation stabilizers, paraffin inhibitors, asphaltene inhibitors, and the like. Other functional additives may include oxidizer breakers, corrosion inhibitors, compressed gases, foaming agents, and similar chemicals that improve the performance of the fracturing fluid.

In one or more embodiments treatment fluids may be combined with one or more fluid loss additives to reduce the leak off of fluid components into the formation surrounding the fracture. In some embodiments, fluid loss additives may be polymeric fluid loss additives such as starches or gums. Fluid loss additives may also include particulate solids including fine mesh sand such as 100 mesh sand, mica flakes, and other small solids designed to reduce fluid loss into narrow fractures. In some embodiments, fluid loss additives may be employed where a formation contains planes of weakness intersected by the main trunk fracture and it is desired to avoid creating and propping open a complex fracture network.

Fracturing operations in accordance with the present disclosure may be used in combination with enhanced recovery techniques that improve fracture initiation such as acid spearheading and high viscosity pill injection, or such techniques may be modified to contain treatment fluid materials. In some embodiments, a spearheading treatment may be injected to remove formation damage or increase permeability prior to injection of treatment fluids in accordance with the present disclosure. Methods may also include pumping a tail-in fluid following treatment fluids in accordance with the present disclosure that may be designed to improve the near wellbore connectivity to one or more hydraulic fractures and prevent unintentional fracture pinchout at the wellbore. In some embodiments, tail-in fluids may include proppant and additional proppant flowback control additives such as resin coated proppant, geometrically diverse proppants such as rods or ellipsoids, particulates, fibers, and other solids.

Other potential applications in accordance with the present disclosure may include the use of diversion pills, such as BROADBAND™ sequence pills available from Schlumberger Technology Corporation, to improve the wellbore coverage of treatment fluids in accordance with the present disclosure. In embodiments incorporating diversion pills, a diversion pill may be pumped after a treatment fluid containing a sequence of alternating pulses of polymeric proppants and spacer fluid to inhibit fracture growth in a selected location. For example, a diversion treatment may be applied to one particular perforation cluster to limit growth, while diverting subsequent treatments to other intervals and enabling fractures to initiate at new perforation clusters previously surrounding by more permeable formation intervals.

Treatment and fracturing fluids in accordance with the present disclosure may be emplaced to stabilize fracture networks anywhere conventional proppants or sand are used, in addition to smaller fracture networks and applications otherwise unsuitable for standard proppant materials. In some embodiments, polymeric proppants may be incorporated into the total volume of a fracturing fluid or into smaller fluid volumes such as in a pad placed before or after a fracturing fluid.

Wellbore Fluids

Base fluids useful for preparing treatment fluid formulations in accordance with the present disclosure may include at least one of fresh water, sea water, brine, mixtures of water and water-soluble organic compounds, and mixtures thereof. In various embodiments, the aqueous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts.

Additionally, brines that may be used in the treatment fluids disclosed herein may be natural or synthetic, with synthetic brines tending to be much simpler in constitution. In one embodiment, the density of the wellbore fluid may be controlled by increasing the salt concentration in the brine (up to saturation, for example). In a particular embodiment, a brine may include halide or carboxylate salts of mono- or divalent cations of metals, such as cesium, potassium, calcium, zinc, and/or sodium.

Other suitable base fluids useful in methods described herein may be oil-in-water emulsions or water-in-oil emulsions in one or more embodiments. Suitable oil-based or oleaginous fluids that may be used to formulate emulsions may include a natural or synthetic oil and in some embodiments, the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

### Examples

In the following example, the compressive strength of the polymer materials that included high-impact grafted polystyrene (HIPS), PMMA, and elastomeric HNBR reinforced by carbon black were tested at varying temperatures. Results have shown that the tested polymers have compressive strength as high as 10,000 psi at elevated temperatures, while the HNBR elastomer can hold up to 2,000 psi compressive strength.

Conductivity test results showed that fractures propped with HIPS polymeric proppants exhibited infinite permeability and conductivity at 126° F. (52° C.) and 3,000 psi closure stress; an average of 19,000 to 22,000 mD-ft conductivity and 10,000 mD permeability at 130° F. (54° C.) and 5,000 psi; and an average of 22,000-26,000 mD-ft conductivity and 12,000 mD permeability at (54° C.) and 7,000 psi. The fractures propped with HNBR polymeric proppants exhibited infinite permeability and conductivity at 3,000 psi closure stress at 126° F. (52° C.); and at 7000 psi closure stress at 130° F. (54° C.).

Although only a few examples have been described in detail above, those skilled in the art will readily appreciate that many modifications are possible in the examples without materially departing from this subject disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed:

1. A method of treating a subterranean formation penetrated by a wellbore, comprising: pumping a treatment fluid comprising one or more polymeric proppants into the formation at a pressure sufficient to initiate a fracture, wherein the one or more polymeric proppants are composed of one or more polymers selected from a group consisting of: polyethylene, polypropylene, butylene, polystyrenes (PS) and copolymers thereof, high-impact grafted polystyrene (HIPS), acrylic polymers, methacrylic polymers, polyvinyl chloride (PVC), polyvinyl acetate (PVA), polycarbonate (PC), hydrogenated nitrile butadiene rubber (HNBR), ethyelene propylene diene monomer (EPDM), polydimethylsiloxane (PDMS), natural rubber, polystyrene-polybutadiene (PS-PB) copolymers, polymethylmethacrylate (PMMA), polystyrene-block-polymethylmethacrylate (PS-b-PMMA), acrylonitrile butadiene styrene (ABS), and epoxy resins.

2. The method of claim 1, wherein the subterranean formation is an unconventional reservoir.

3. The method of claim 2, wherein the unconventional reservoir is a shale reservoir.

4. The method of claim 1, wherein the one or more polymeric proppants further comprise a water-absorbing material.

5. The method of claim 1, wherein the particle size of the one or more polymeric proppants is in the range of 100 nm to 2 mm.

6. The method of claim 1, wherein the one or more polymeric proppants have shapes selected from the group consisting of spherical, rod, and combinations thereof.

7. The method of claim 1, wherein the one or more polymeric proppants have a density in the range of 0.5 g/cm³ to 1.7 g/cm³.

8. The method of claim 1, wherein the one or more polymeric proppants has an elastic modulus in the range of 5,000 psi and 200,000 psi.

9. The method of claim 1, wherein the treatment fluid is a multistage fracturing fluid comprising at least one polymer proppant-containing stage and at least one spacer fluid, and wherein the ratio of the polymerizable phase to spacer may range from 1:0.5 to 0.5:1.

10. A method, comprising:
introducing a multistage treatment fluid into one or more intervals of a wellbore, wherein the multistage treatment fluid comprises one or more stages of a polymeric proppant-containing fluid and one or more stages of a spacer fluid.

11. The method of claim 10, wherein the one or more intervals of a wellbore are present in a shale formation.

12. The method of claim 10, wherein the concentration of the polymeric proppant in the one or more stages of polymeric proppant-containing fluids is in the range of 0.1 ppb to 14 ppb.

13. The method of claim 10, wherein the polymeric proppant in the one or more stages of polymeric proppant-containing fluids comprises a water-absorbing material at a concentration that ranges from 0.01 wt % to 5 wt %.

14. The method of claim 10, wherein the polymeric proppants in the one or more stages of polymeric proppant-containing fluids comprise one or more selected from a group consisting of: polyethylene, polypropylene, butylene, polystyrenes (PS) and copolymers thereof, acrylic polymers, methacrylic polymers, polyvinyl chloride (PVC), polyvinyl acetate (PVA), polycarbonate (PC), hydrogenated nitrile butadiene rubber (HNBR), ethyelene propylene diene monomer (EPDM), polydimethylsiloxane (PDMS), natural rubber, polystyrene-polybutadiene (PS-PB) copolymers, polystyrene-block-polymethylmethacrylate (PS-b-PMMA), acrylonitrile butadiene styrene (ABS), and epoxy resins.

15. The method of claim 10, wherein the particle size of the polymeric proppants in the one or more stages of polymeric proppant-containing fluids is in the range of 100 nm to 2 mm.

16. The method of claim 10, wherein the polymeric proppants in the one or more stages of polymeric proppant-containing fluids have a density in the range of 0.5 g/cm³ to 1.7 g/cm³.

17. The method of claim 10, wherein the polymeric proppants in the one or more stages of polymeric proppant-containing fluids has an elastic modulus in the range of 5,000 psi and 200,000.

18. The method of claim 10, wherein the volume of each of the one or more stages of the polymeric proppant-containing fluid is within the range of from 2 to 10 bbl.

19. The method of claim 10, wherein introducing a multistage treatment fluid into one or more intervals of a wellbore comprises injecting the one or more stages of the polymeric proppant-containing fluid and the one or more stages of the spacer fluid in sequence, wherein each stage is pumped for a duration that may range from 5 to 20 seconds, and at an injection rate that ranges from 5 to 60 bbl/min.
